(19) United States
(12) Patent Application Publication
(10) Pub. No.: US 2025/0182464 A1
(43) Pub. Date: Jun. 5, 2025

(54) INFORMATION PROCESSING APPARATUS, COMPUTER READABLE STORAGE MEDIUM, AND INFORMATION PROCESSING METHOD

(71) Applicant: SoftBank Corp., Tokyo (JP)

(72) Inventors: Yuko ISHIWAKA, Tokyo (JP); Kazuto SUDA, Tokyo (JP)

(21) Appl. No.: 19/051,153

(22) Filed: Feb. 11, 2025

Related U.S. Application Data
(63) Continuation of application No. PCT/JP2023/033865, filed on Sep. 19, 2023.

(30) Foreign Application Priority Data
Nov. 11, 2022 (JP) 2022-181014

(51) Int. Cl. G06V 10/82

(52) U.S. Cl. CPC G06V 10/82

(57) ABSTRACT

Provided is an information processing apparatus, comprising: a learning execution unit that generates a neural network which has a visual pathway layer generated by executing learning based on a configuration of a visual pathway in a visual cortex and which takes an image as input and provides information related to an object included in the image as output; and a storage unit that stores the neural network generated by the learning execution unit. Provided is an information processing method executed by a computer, the information processing method comprising; executing learning to generate a neural network which has a visual pathway layer generated by executing learning based on a configuration of a visual pathway in a visual cortex and which takes an image as input and provides information related to an object included in the image as output; and storing the neural network generated by the learning execution unit.

The contents of the following patent application(s) are incorporated herein by reference:

NO. 2022-181014 filed in JP on Nov. 11, 2022

NO. PCT/JP2023/033865 filed in WO on Sep. 19, 2023.

### BACKGROUND

### 1. Technical field

The present invention relates to an information processing apparatus, a computer readable storage medium, and an information processing method.

### 2. Related Art

Patent Document 1 describes a technique for obtaining a facial image of a user and authenticating the user by using information related to the feature point included in the facial image.

### PRIOR ART DOCUMENTS

### Patent document

Patent Document 1: Japanese Patent Application Publication No. 2021-170205

### BRIEF DESCRIPTION OF THE DRAWINGS

FIG. 1 schematically illustrates an example of a system 10.

FIG. 2 is a descriptive illustration of a neural network 300 generated by a learning apparatus 100.

FIG. 3 schematically illustrates an example of a functional configuration of the learning apparatus 100.

FIG. 4 illustrates a relationship between response speed and average firing rate of a neuron response to an edge with a certain angle.

FIG. 5 schematically illustrates an example of a hardware configuration of a computer 1200 functioning as the learning apparatus 100 or an authentication apparatus 200.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solving means of the invention.

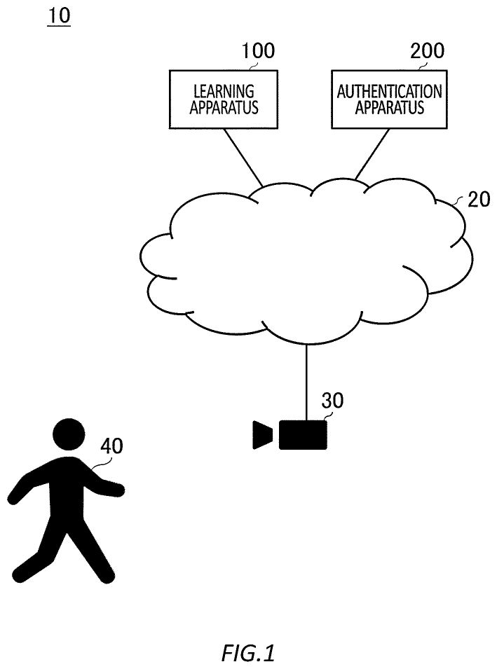

FIG. 1 schematically illustrates an example of a system 10. The present embodiment mainly exemplifies and describes a case in which the system 10 is a face authentication system.

The system 10 includes a learning apparatus 100. The learning apparatus 100 may be an example of an information processing apparatus. The system 10 may include an authentication apparatus 200. The system 10 may include a camera 30.

Conventional face authentication systems use a large amount of training data with a large-scale Deep Neural Network utilizing CNN (Convolutional Neural Network) to cause feature values to be learned. However, this approach is based on so-called brute force and does not consider how humans recognize other humans. The learning apparatus 100 pertaining to the present embodiment uses the neural network, for example, that imitates a visual pathway in a visual cortex of a human, so that the training amount can be reduced, sensing and/or recognition equivalent to or better than a human can be performed with a small amount of training data, and contribution can be made to obtaining a precision required for authentication. Note that, the learning apparatus 100 may be able to implement not only facial recognition but also sensing and/or recognition of any object by using images.

The learning apparatus 100 and the authentication apparatus 200 may communicate with each other via a network 20. The learning apparatus 100 and the camera 30 may communicate with each other via the network 20. The authentication apparatus 200 and the camera 30 may communicate with each other via the network 20.

The network 20 may include the Internet. The network 20 may include a LAN (Local Area Network). The network 20 may include a mobile communication network. The mobile communication network may conform to any of the 3G (3rd Generation) communication system, the LTE (Long Term Evolution) communication system, the 5G (5th Generation) communication system, and the 6G (6th Generation) communication system and the communication system of the subsequent generation.

The learning apparatus 100 may be wired to the network 20. The learning apparatus 100 may be wirelessly connected to the network 20. The learning apparatus 100 may be connected to the network 20 via a wireless base station. The learning apparatus 100 may be connected to the network 20 via a Wi-Fi (registered trademark) access point.

The authentication apparatus 200 may be wired to the network 20. The authentication apparatus 200 may be wirelessly connected to the network 20. The authentication apparatus 200 may be connected to the network 20 via a wireless base station. The authentication apparatus 200 may be connected to the network 20 via a Wi-Fi (registered trademark) access point.

The camera 30 may be wired to the network 20. The camera 30 may be wirelessly connected to the network 20. The camera 30 may be connected to the network 20 via a wireless base station. The camera 30 may be connected to the network 20 via a Wi-Fi access point.

The authentication apparatus 200 and the camera 30 may be directly connected. In addition, the authentication apparatus 200 may incorporate the camera 30.

The learning apparatus 100 generates a neural network by executing learning. The learning apparatus 100 may generate the neural network which takes an image as input and provides information related to an object included in the image as output. The learning apparatus 100 may generate the neural network which has visual pathway layers generated by executing learning based on a configuration of a visual pathway in a visual cortex. In the present example, the learning apparatus 100 generates the neural network for performing facial recognition.

The authentication apparatus 200 performs facial recognition by using the neural network generated by the learning apparatus 100. The authentication apparatus 200 receives, from the camera 30, a captured image captured by the camera 30. The camera 30 captures an image of a person 40 who is the object of facial recognition, and transmits the captured image to the authentication apparatus 200. The said captured image may be a moving image.

The camera 30 is installed in any location where authentication of the person 40 is required. When the authentication apparatus 200 incorporates the camera 30, the authentication apparatus 200 may be installed in any location where authentication of the person 40 is required.

Note that, the learning apparatus 100 and the authentication apparatus 200 may be a single-piece construction. That is, the learning apparatus 100 may also serve as the authentication apparatus 200. In this case, the learning apparatus 100 includes the functionality of the authentication apparatus 200.

In addition, although the present embodiment mainly exemplifies and describes a case in which the system 10 is a face authentication system, the system is not limited to this. The system 10 may be a system that performs at least any of sensing, recognition, and authentication of any object using images. In this case, the learning apparatus 100 may generate a neural network which performs at least any of sensing, recognition, and authentication of any object.

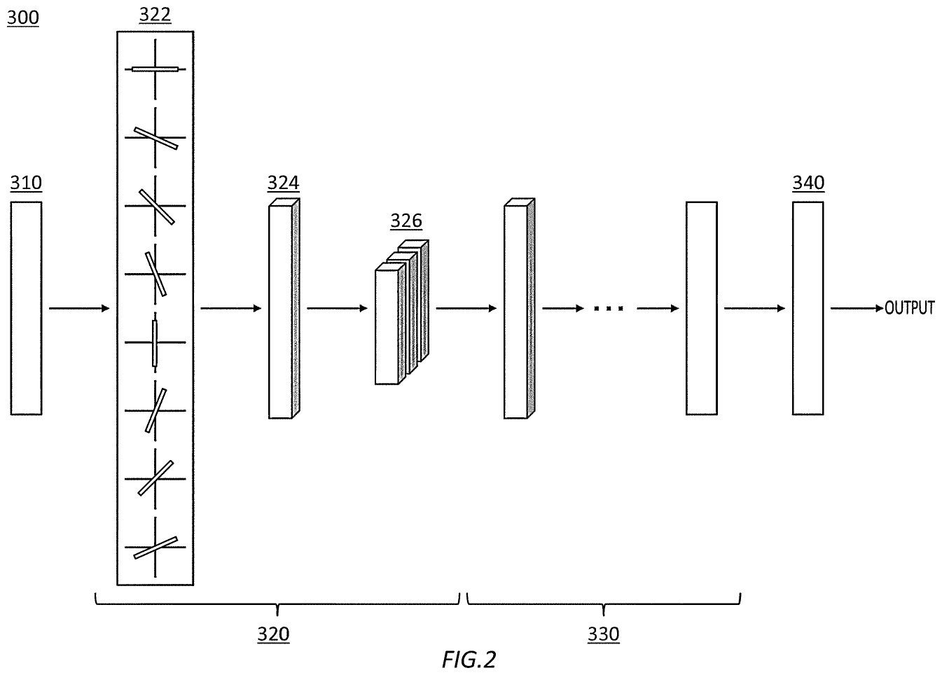

FIG. 2 is a descriptive illustration of a neural network 300 generated by the learning apparatus 100. The neural network 300 includes an input layer 310, a visual pathway layer 320, a training layer 330, and a softmax 340.

External optical information is accepted on visual cells in the eyeball retina and thereafter the visual information is processed. The flow of the visual information may be referred to as a visual pathway. Various researches have been conducted on how the brain processes the visual information when determining an object, and clarification of the configuration of the visual pathway is proceeding. The learning apparatus 100 pertaining to the present embodiment reflects, to the neural network 300, a clarified part of the configuration of the visual pathway in the visual cortex.

The visual cortex includes the primary visual cortex (V1), secondary visual cortex (V2), tertiary visual cortex (V3), quaternary visual cortex (V4), and quinary visual cortex (V5). V5 may be referred to as MT (Middle temporal) area. Since V1, V2, V3, V4, and V5 are complexly interlinked, defining each function uniformly is difficult, yet as a representative function, V1 has orientation selectivity. The orientation selectivity represents a property of a neuron to selectively respond to a specific gradient in a visual stimulus. V2 has orientation selectivity that is finer than that of V1, responsiveness to a thickness or thinness of an edge, and responsiveness to black and white. V5 has direction selectivity. The direction selectivity represents a property of a neuron to selectively respond to a certain motion direction in a visual stimulus.

For example, the orientation selectivity in the primary visual cortex has been clarified in researches such as “Receptive fields of single neurones in the cat's striate cortex. Journal of Physiology, pp.574-591,1959”. In the primary visual cortex, there are neurons that fire for each of the angles of edges included in a visual stimulus.

The learning apparatus 100 generates the primary visual cortex layer 322 by learning to reproduce the orientation selectivity in the primary visual cortex. For example, the learning apparatus 100 generates the primary visual cortex layer 322 in which a neuron corresponding to an angle of an edge included in an input image fires, by using learning data in which angles of edges included in an image are correspondingly registered with neurons that should fire for each of the angles.

Also, the property of the secondary visual cortex has been clarified in “Representation of angles embedded within contour stimuli in area V2 of macaque monkeys. The journal of neuroscience: the official journal of the Society for Neuroscience, pp.3313-24, 2004”, for example. In the secondary visual cortex, there are neurons that have the orientation selectivity finer than the orientation selectivity of the primary visual cortex. In addition, in the secondary visual cortex, there are neurons that respond to the thickness or thinness of edges, neurons that respond to black and white, neurons that respond to spatial frequencies, and neurons that respond to colors.

The learning apparatus 100 generates the secondary visual cortex layer 324 by learning to reproduce the property of the secondary visual cortex. For example, the learning apparatus 100 generates the secondary visual cortex layer 324 by learning to reproduce the orientation selectivity in the secondary visual cortex which is finer than the orientation selectivity in the primary visual cortex.

Also, the quinary visual cortex has been clarified in “Functional properties of neurons in middle temporal visual cortex of the macaque monkey. I. Selectivity For stimulus direction, speed, and orientation. Journal of Neurophysiology. pp.1127-1147, 1983”, for example. In the quinary visual cortex, there are neurons that fire for each of motion directions of edges included in the visual stimulus and neurons that respond to movement speeds of edges.

The learning apparatus 100 generates the quinary visual cortex layer 326 by learning to reproduce the direction selectivity in the quinary visual cortex. For example, the learning apparatus 100 generates the quinary visual cortex layer 326 in which a neuron corresponding to a motion direction of an edge included in an input image fires, by using learning data in which motion directions of edges included in an image are correspondingly registered with neurons that should fire for each of the motion directions. For example, the learning apparatus 100 is defined as layers handling a complex that responds to upward if the right and the left respond.

The learning apparatus 100 generates the training layer 330 by learning that uses annotated training data according to purposes. For example, for the purpose of facial recognition, the learning apparatus 100 executes learning that uses a large amount of annotated facial images as the training data.

As in the present example, when targeting a classification problem such as facial recognition, the neural network 300 includes softmax 340. Depending on purposes, the neural network 300 may not include the softmax 340. For example, when targeting a regression problem, the neural network 300 may include an identity function instead of the softmax 340.

Although it is possible to generate the entirety of the neural network 300 by using a large amount of training data, an enormous amount of time is required for computing. In addition, the load to collect training data becomes very large. In contrast, according to the learning apparatus 100 pertaining to the present embodiment, by using the neural network which imitates the visual pathway in the visual cortex, unnecessary training can be omitted, sensing and/or recognition equivalent to or better than a human can be performed with a smaller amount of training data compared to the case in which the entirety of the neural network is generated by training, and a precision required for authentication can be obtained.

Note that, the visual pathway layer 320 may include only the primary visual cortex layer 322 and the secondary visual cortex layer 324. That is, the learning apparatus 100 may generate the neural network 300 by generating the primary visual cortex layer 322 and the secondary visual cortex layer 324, and generating the layers thereafter using training data.

In addition, the visual pathway layer 320 may include only the primary visual cortex layer 322. That is, the learning apparatus 100 may generate the neural network 300 by generating the primary visual cortex layer 322, and generating the layers thereafter using training data.

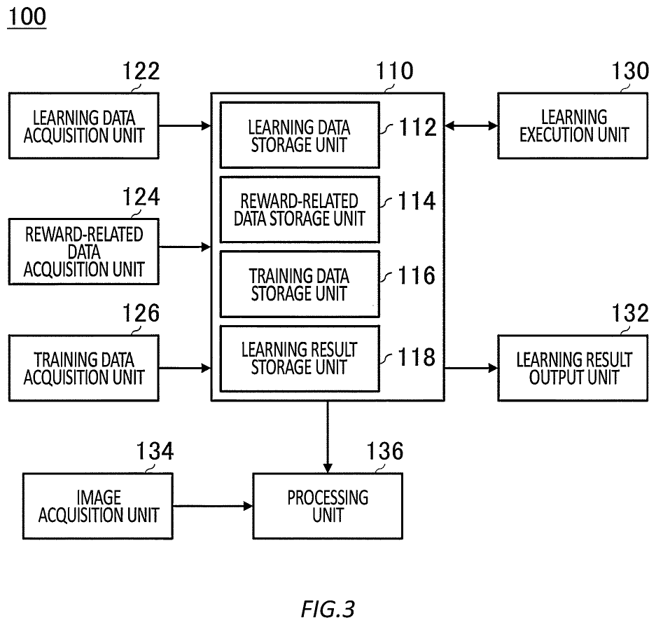

FIG. 3 schematically illustrates an example of a functional configuration of the learning apparatus 100. FIG. 3 exemplifies the functional configuration in which the learning apparatus 100 also serves as the authentication apparatus 200. The learning apparatus 100 includes a storage unit 110, a learning data acquisition unit 122, a reward-related data acquisition unit 124, a training data acquisition unit 126, a learning execution unit 130, a learning result output unit 132, an image acquisition unit 134, and a processing unit 136. Note that the learning apparatus 100 does not necessarily include all of these configurations.

The storage unit 110 stores various types of data. The storage unit 110 includes a learning data storage unit 112, a reward-related data storage unit 114, a training data storage unit 116, and a learning result storage unit 118.

The learning data acquisition unit 122 acquires learning data. The learning data acquisition unit 122 may acquire the learning data that is generated in the learning apparatus 100 by users or the like of the learning apparatus 100. The learning data acquisition unit 122 may receive the learning data from other apparatuses. The learning data acquisition unit 122 causes the acquired learning data to be stored in the learning data storage unit 112.

The learning data acquisition unit 122 may acquire the learning data to be used for generating the primary visual cortex layer 322. The learning data acquisition unit 122 may acquire the learning data in which angles of edges included in an image are correspondingly registered with neurons that should fire for each of the angles.

The learning data acquisition unit 122 may acquire the learning data to be used for generating the secondary visual cortex layer 324. The learning data acquisition unit 122 may acquire the learning data in which angles of edges included in an image are correspondingly registered with neurons that should fire for each of the angles. The learning data acquisition unit 122 may acquire the learning data in which thicknesses of edges included in an image are correspondingly registered with neurons that should fire for each of the thicknesses.

The learning data acquisition unit 122 may acquire the learning data to be used for generating the quinary visual cortex layer 326. The learning data acquisition unit 122 may acquire the learning data in which motion directions of edges included in an image are correspondingly registered with neurons that should fire for each of the motion directions.

The reward-related data acquisition unit 124 acquires reward-related data that is related to rewards at the time of learning of the visual pathway layer 320. The reward-related data will be described below. The reward-related data acquisition unit 124 may acquire the reward-related data that is generated in the learning apparatus 100 by users or the like of the learning apparatus 100. The reward-related data acquisition unit 124 may receive the reward-related data from other apparatuses. The reward-related data acquisition unit 124 may cause the acquired reward-related data to be stored in the reward-related data storage unit 114.

The training data acquisition unit 126 may acquire training data. The training data acquisition unit 126 may acquire the training data to be used for generating the training layer 330. The training data acquisition unit 126 may acquire the training data that is prepared by users or the like of the learning apparatus 100. The training data acquisition unit 126 may receive the training data from other apparatuses. The training data acquisition unit 126 causes the acquired training data to be stored in the training data storage unit 116.

The learning execution unit 130 executes learning and generates the neural network. The learning execution unit 130 generates the neural network which has the visual pathway layer generated by executing learning based on the configuration of the visual pathway in the visual cortex and which takes an image as input and provides information related to an object included in the image as output. The learning execution unit 130 may generate the neural network which has the visual pathway layer and the training layer which is generated by learning that uses the annotated training data. The learning execution unit 130 causes the generated neural network to be stored in the learning result storage unit 118.

The learning execution unit 130 may generate the neural network which has the visual pathway layer including the primary visual cortex layer which has learned to reproduce the orientation selectivity in the primary visual cortex. This can eliminate the need for the amount of training data that is required for the neural network to obtain the ability corresponding to the orientation selectivity, allowing learning to be more efficient.

The learning execution unit 130 may generate the primary visual cortex layer in which a neuron corresponding to an edge included in an input image fires, by using the learning data which is stored in the learning data storage unit 112 and in which angles of edges included in an image are correspondingly registered with neurons that should fire for each of the angles.

For example, the learning execution unit 130 may use the said learning data to learn the primary visual cortex layer by an autoencoder. As the learning data indicates, it has been clarified which neuron should fire at which angle, and the learning execution unit 130 learns to be able to reproduce this by the autoencoder.

Specifically, the learning execution unit 130 sets, for example, output nodes to be (0, 90, 180, −90, or the like) relative to preset angles (0, 90, 180, −90, or the like), defines that an input more than an upper limit threshold is 1 and an input equal to or less than a lower limit threshold is 0 so that only the node of 0 responds when 0 is input, sets a loss function so that one or only the set number of neurons fire, and modifies a weight by the autoencoder.

The learning execution unit 130 may learn the primary visual cortex layer not by the autoencoder but by reinforcement learning with time-delay rewards in which the desired input and the desired output are the same but the weight of the synapse based thereon is modified. The learning execution unit 130 may modify the weight by using stochastic gradient descent (SGD). For example, the learning execution unit 130 generates the primary visual cortex layer by executing the reinforcement learning which modifies the weight according to the response speed of the neurons which differs for each of the angles of the edges.

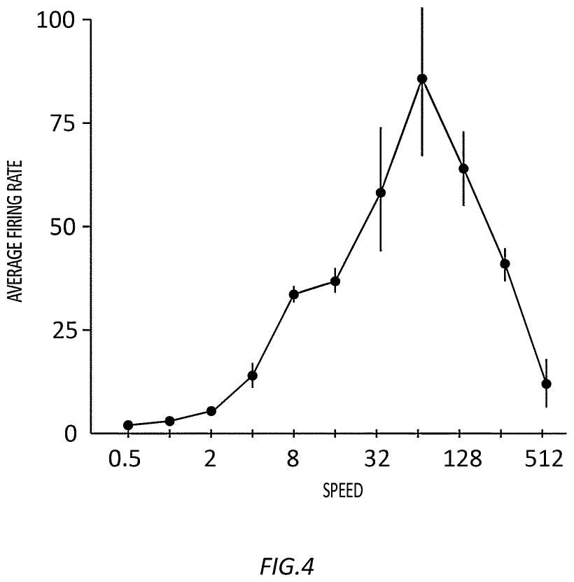

FIG. 4 illustrates a relationship between response speed and average firing rate of a neuron response to an edge with a certain angle. As FIG. 4 indicates, a time delay occurs in the response of the neuron. Therefore, when the neuron shows a correct response, the reward should be given not to an input at the timing of the correct response but to an input earlier than that timing. For a response of the neuron to the edge with the said angle, the learning execution unit 130 gives the reward to input based on the relationship indicated in FIG. 4.

The relationship between the response speed and the average firing rate differs depending on the angle of the edge. The reward-related data acquisition unit 124 may acquire the reward-related data that indicates the relationship between the response speed and the average firing rate for each of the angles of the edges. Using the reward-related data stored in the reward-related data storage unit 114, the learning execution unit 130 gives the reward to input for the response of the neuron to each of the angles of the edges.

Specifically, the learning execution unit 130 modifies the weight so that a response is made to the angles (for example, in every 10 degrees) that are finer than the learned layer (typical angles and responding neurons) in V1. Specifically, the weight of the network is updated so that a plurality of neurons overlap and fire for the left 10 degrees and the left 20 degrees. The weight is updated so that the neuron for 90 degrees fires when the left 0 degrees and the right 0 degrees respond (180 degrees). These fine data sets are prepared in advance as a space frequency data set as training data.

The learning execution unit 130 may generate the neural network which has the visual pathway layer including the secondary visual cortex layer which has learned to reproduce the orientation selectivity in the secondary visual cortex which is finer than the orientation selectivity in the primary visual cortex. That is, the learning execution unit 130 may generate the neural network which has the visual pathway layer including the primary visual cortex layer and the secondary visual cortex layer. This can eliminate the need for the amount of training data that is required for the neural network to obtain the ability corresponding to the orientation selectivity in the primary visual cortex and the orientation selectivity in the secondary visual cortex, allowing learning to be more efficient.

The learning execution unit 130 may generate the secondary visual cortex layer in which a neuron corresponding to an edge included in an input image fires, by using the learning data which is stored in the learning data storage unit 112 for generating the secondary visual cortex layer and in which angles of edges included in an image are correspondingly registered with neurons that should fire for each of the angles.

The learning execution unit 130 may learn the secondary visual cortex layer by an autoencoder in a similar way to the primary visual cortex layer. The learning execution unit 130 may learn the secondary visual cortex layer not by the autoencoder but by reinforcement learning with time-delay rewards in which the desired input and the desired output are the same but the weights of the synapse based thereon are modified, in a similar way to the primary visual cortex layer.

Specifically, the learning execution unit 130 may use the connection of neurons and firing of neurons as a state-action pair and give the reward when the neuron that should fire fires on the same learning set as that for the autoencoder. Using an update equation of reinforcement learning, a value of the state-action pair when the state is back in time by a preset lag time is updated by the reward. The update equation of reinforcement learning may be Q-learning, or learning by Deep Reinforcement Learning may be used.

The learning execution unit 130 may generate the neural network which has the visual pathway layer including the quinary visual cortex layer which has learned to reproduce the direction selectivity in the quinary visual cortex. That is, the learning execution unit 130 may generate the neural network which has the visual pathway layer including the primary visual cortex layer, the secondary visual cortex layer, and the quinary visual cortex layer. This can eliminate the need for the amount of training data that is required for the neural network to obtain the ability corresponding to the orientation selectivity in the primary visual cortex, the orientation selectivity in the secondary visual cortex, and the direction selectivity in the quinary visual cortex, allowing learning to be more efficient.

The learning execution unit 130 may generate the quinary visual cortex layer in which a neuron corresponding to a motion direction of an edge included in an input image fires, by using the learning data which is stored in the learning data storage unit 112 for generating the quinary visual cortex layer and in which motion directions of edges included in an image are correspondingly registered with neurons that should fire for each of the motion directions.

The learning execution unit 130 may learn the quinary visual cortex layer by an

autoencoder in a similar way to the primary visual cortex layer. The learning execution unit 130 may learn the quinary visual cortex layer not by the autoencoder but by reinforcement learning with time-delay rewards in which the desired input and the desired output are the same but the weights of the synapse based thereon are modified, in a similar way to the primary visual cortex layer.

Specifically, the learning execution unit 130 may use the connection of neurons and firing of neurons as a state-action pair and give the reward when the neuron that should fire fires on the same learning set as that for the autoencoder. Using an update equation of reinforcement learning, a value of the state-action pair when the state is back in time by a preset lag time is updated by the reward. The update equation of reinforcement learning may be Q-learning, or learning by Deep Reinforcement Learning may be used.

The learning execution unit 130 may use RNN (Recurrent Neural Network) as a learning model. The learning execution unit 130 may use a spiking neural network as learning. The learning execution unit 130 may generate the neural network which has the visual pathway layer configured by the spiking neural network. The learning execution unit 130 may generate the neural network which has the visual pathway layer and the training layer configured by the spiking neural network. By using the spiking neural network, the robustness of the neural network generated by the learning execution unit 130 can be increased. Note that, the learning execution unit 130 may use other learning models.

The learning result output unit 132 outputs the neural network stored in the learning result storage unit 118. For example, the learning result output unit 132 transmits the neural network stored in the learning result storage unit 118 to another apparatus.

The image acquisition unit 134 acquires an image. The image acquisition unit 134 acquires a moving image input as an analysis object.

The processing unit 136 inputs the image acquired by the image acquisition unit 134 into the neural network stored in the learning result storage unit 118 and outputs information related to the object included in the said image. For example, the processing unit 136 transmits the information related to the object included in the image to an apparatus that has input the said image.

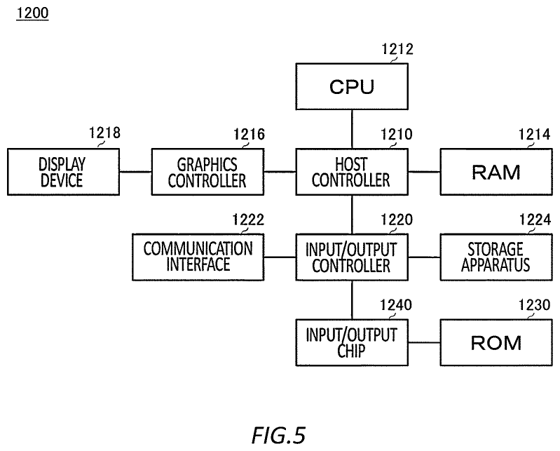

FIG. 5 schematically illustrates an example of a hardware configuration of a computer 1200 functioning as the learning apparatus 100 or an authentication apparatus 200. A program installed in the computer 1200 can cause the computer 1200 to function as one or more “units” of an apparatus according to the present embodiment, or cause the computer 1200 to perform operations associated with the apparatus or perform said one or more “units” thereof according to the present embodiment, and/or cause the computer 1200 to perform the process according to the present embodiment or perform the steps of the said process. Such a program may be executed by a CPU 1212 to cause the computer 1200 to execute specific operations associated with some or all of the blocks in the flowcharts and block diagrams described in the present specification.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage apparatus 1224, a DVD drive and an IC card drive, which are connected to the host controller 1210 via an input/output controller 1220. The DVD drive may be a DVD-ROM drive, and a DVD-RAM drive, etc. The storage apparatus 1224 may be a hard disk drive, a solid-state drive, and the like. The computer 1200 also includes a ROM 1230 and a legacy input/output unit such as a keyboard, which are connected to the input/output controller 1220 via an input/output chip 1240.

The CPU 1212 operates in accordance with the programs stored in the ROM 1230 and the RAM 1214, thereby controlling each unit. The graphics controller 1216 obtains image data which is generated by the CPU 1212 in a frame buffer or the like provided in the RAM 1214 or in itself so as to cause the image data to be displayed on a display device 1218.

The communication interface 1222 communicates with other electronic devices via a network. The storage apparatus 1224 stores a program and data used by the CPU 1212 in the computer 1200. The DVD drive reads the programs or the data from the DVD-ROM or the like, and provides the storage apparatus 1224 with the programs or the data. The IC card drive reads programs and data from an IC card and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer readable storage medium such as the DVD-ROM or the IC card. The program is read from the computer readable storage medium, installed into the storage apparatus 1224, RAM 1214, or ROM 1230, which are also examples of a computer readable storage medium, and executed by the CPU 1212. Information processing written in these programs is read by the computer 1200, and provides cooperation between the programs and the various types of hardware resources described above. An apparatus or method may be configured by implementing the operation or processing of information in accordance with the usage of the computer 1200.

For example, when a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage apparatus 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive (DVD-ROM), the IC card, etc., and perform various types of processing on the data on the RAM 1214. Next, the CPU 1212 may write the processed data back into the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the said plurality of entries, and read the attribute value of the second attribute stored in the said entry, thereby obtaining the attribute value of the second attribute associated with the first attribute that satisfies a predetermined condition.

The above described program or software modules may be stored in the computer readable storage medium on or near the computer 1200. In addition, a recording medium such as a hard disk or a RAM provided in a server system connected to a dedicated communication network or the Internet can be used as the computer readable storage medium, thereby providing the program to the computer 1200 via the network.

Blocks in flowcharts and block diagrams in the present embodiments may represent stages of processes in which operations are executed or “units” of apparatuses responsible for executing operations. A specific stage and “unit” may be implemented by dedicated circuit, programmable circuit supplied along with a computer readable instruction stored on a computer readable storage medium, and/or a processor supplied along with the computer readable instruction stored on the computer readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer readable storage medium may include any tangible device capable of storing an instruction executed by an appropriate device, so that the computer readable storage medium having the instruction stored thereon constitutes a product including an instruction that may be executed in order to provide means for executing an operation designated by a flowchart or a block diagram. Examples of the computer readable storage medium may include an electronic storage medium, a magnetic storage medium, an optical storage medium, an electromagnetic storage medium, a semiconductor storage medium, and the like. More specific examples of the computer readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, or the like, and a conventional procedural programming language such as a “C” programming language or a similar programming language.

The computer readable instruction may be provided to a general purpose computer, a special purpose computer, or a processor or programmable circuit of another programmable data processing apparatus locally or via a local area network (LAN), a wide area network (WAN) such as the Internet or the like in order that the general purpose computer, the special purpose computer, or the processor or the programmable circuit of another programmable data processing apparatus executes the said computer readable instruction to generate means for executing operations designated by the flowchart or the block diagram. Examples of the processor include a computer processor, a processing unit, a microprocessor, a digital signal processor, a controller, a microcontroller, and the like.

While the present invention has been described above by using the embodiments, the technical scope of the present invention is not limited to the scope of the above-described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by a device, system, program, and method shown in the claims, embodiments, or diagrams can be implemented in any order as long as the order is not indicated by “prior to,” “before,” or the like and as long as the output from a previous process is not used in a later process. Even if the process flow is described using phrases such as “first” or “next” in the claims, specification, or diagrams, it does not necessarily mean that the process must be performed in this order.

### EXPLANATION OF REFERENCES

10: system, 20: network, 30: camera, 40: person, 100: learning apparatus, 110: storage unit, 112: learning data storage unit, 114: reward-related data storage unit, 116: training data storage unit, 118: learning result storage unit, 122: learning data acquisition unit, 124: reward-related data acquisition unit, 126: training data acquisition unit, 130: learning execution unit, 132: learning result output unit, 134: image acquisition unit, 136: processing unit, 200: authentication apparatus, 300: neural network, 310: input layer, 320: visual pathway layer, 322: primary visual cortex layer, 324: secondary visual cortex layer, 326: quinary visual cortex layer, 330: training layer, 340: softmax, 1200: computer, 1210: host controller, 1212: CPU. 1214: RAM, 1216: graphics controller, 1218: display device, 1220: input/output controller, 1222: communication interface, 1224: storage apparatus, 1230: ROM, 1240: input/output chip.

What is claimed is:

1. An information processing apparatus, comprising:
a learning execution unit that generates a neural network which has a visual pathway layer generated by executing learning based on a configuration of a visual pathway in a visual cortex and which takes an image as input and provides information related to an object included in the image as output; and
a storage unit that stores the neural network generated by the learning execution unit.

2. The information processing apparatus according to claim 1, wherein
the learning execution unit generates the neural network which has the visual pathway layer including a primary visual cortex layer which has learned to reproduce orientation selectivity in a primary visual cortex.

3. The information processing apparatus according to claim 2, wherein
the learning execution unit generates the primary visual cortex layer in which a neuron corresponding to an edge included in an input image fires, by using learning data in which angles of edges included in an image are correspondingly registered with neurons that should fire for each of the angles.

4. The information processing apparatus according to claim 3, wherein
the learning execution unit generates the primary visual cortex layer by executing, on a moving image, reinforcement learning which modifies a weight according to a response speed of the neuron which differs for each of the angles of the edges.

5. The information processing apparatus according to claim 2, wherein
the learning execution unit generates the neural network which has the visual pathway layer including a secondary visual cortex layer which has learned to reproduce orientation selectivity in a secondary visual cortex which is finer than the orientation selectivity in the primary visual cortex.

6. The information processing apparatus according to claim 3, wherein
the learning execution unit generates the neural network which has the visual pathway layer including a secondary visual cortex layer which has learned to reproduce orientation selectivity in a secondary visual cortex which is finer than the orientation selectivity in the primary visual cortex.

7. The information processing apparatus according to claim 4, wherein
the learning execution unit generates the neural network which has the visual pathway layer including a secondary visual cortex layer which has learned to reproduce orientation selectivity in a secondary visual cortex which is finer than the orientation selectivity in the primary visual cortex.

8. The information processing apparatus according to claim 5, wherein
the learning execution unit generates the neural network which has the visual pathway layer including a quinary visual cortex layer which has learned to reproduce direction selectivity in a quinary visual cortex.

9. The information processing apparatus according to claim 6, wherein
the learning execution unit generates the neural network which has the visual pathway layer including a quinary visual cortex layer which has learned to reproduce direction selectivity in a quinary visual cortex.

10. The information processing apparatus according to claim 7, wherein
the learning execution unit generates the neural network which has the visual pathway layer including a quinary visual cortex layer which has learned to reproduce direction selectivity in a quinary visual cortex.

11. The information processing apparatus according to claim 1, wherein
the learning execution unit generates the neural network which has the visual pathway layer configured by a spiking neural network.

12. The information processing apparatus according to claim 2, wherein
the learning execution unit generates the neural network which has the visual pathway layer configured by a spiking neural network.

13. The information processing apparatus according to claim 3, wherein
the learning execution unit generates the neural network which has the visual pathway layer configured by a spiking neural network.

14. The information processing apparatus according to claim 4, wherein
the learning execution unit generates the neural network which has the visual pathway layer configured by a spiking neural network.

15. The information processing apparatus according to claim 5, wherein
the learning execution unit generates the neural network which has the visual pathway layer configured by a spiking neural network.

16. The information processing apparatus according to claim 6, wherein
the learning execution unit generates the neural network which has the visual pathway layer configured by a spiking neural network.

17. The information processing apparatus according to claim 1, wherein
the learning execution unit generates the neural network which has the visual pathway layer and a training layer which is generated by learning which uses annotated training data.

18. The information processing apparatus according to claim 17, comprising:
an image acquisition unit that acquires an image input; and
a processing unit that inputs the image acquired by the image acquisition unit into a neural network stored in the storage unit and outputs information related to an object included in the image.

19. A non-transitory computer readable storage medium storing a program that causes a computer to function as:
a learning execution unit that generates a neural network which has a visual pathway layer generated by executing learning based on a configuration of a visual pathway in a visual cortex and which takes an image as input and provides information related to an object included in the image as output; and
a storage unit that stores the neural network generated by the learning execution unit.

20. An information processing method executed by a computer, the information processing method comprising;
executing learning to generate a neural network which has a visual pathway layer generated by executing learning based on a configuration of a visual pathway in a visual cortex and which takes an image as input and provides information related to an object included in the image as output; and
storing the neural network generated by the executing learning.
